(19) United States
(12) Patent Application Publication
(10) Pub. No.: US 2025/0258768 A1
(43) Pub. Date: Aug. 14, 2025

(54) METHOD FOR STATIC ALLOCATION AND ASSIGNMENT OF INFORMATION TO MEMORY AREAS, INFORMATION TECHNOLOGY SYSTEM AND VEHICLE

(71) Applicant: MERCEDES-BENZ GROUP AG, Stuttgart (DE)

(72) Inventor: Thorsten WILMER, Sindelfingen (DE)

(21) Appl. No.: 18/996,368

(22) PCT Filed: Sep. 18, 2023
(86) PCT No.: PCT/EP2023/075628

§ 371 Date: Jan. 17, 2025

(30) Foreign Application Priority Data
Oct. 5, 2022 (DE) 10 2022 003 674.6

(51) Int. Cl. G06F 12/02

(52) U.S. Cl. CPC G06F 12/023

(57) ABSTRACT

A method for static allocation of information to memory areas of a processor-external memory of an information technology system is provided. A one-time analysis process of the information technology system checks which output data of the functions are processed simultaneously by the processor during an execution iteration and assigns the output data to fixed memory areas, During an execution iteration, the information technology system in the standard operation writes a first item of output data into the fixed memory areas assigned to it and leaves same in the fixed memory area at least until the function requiring the first item of output data has been processed by the processor and writes a second item of output data into the same fixed memory area to replace the first item of output data, before the function which requires the second item of output data is processed by the processor.

### BACKGROUND AND SUMMARY OF THE INVENTION

Exemplary embodiments of the invention relate to a method for static allocation and assignment of information to memory areas of a processor-external memory of an information technology system, to an information technology system for carrying out the method, and to a vehicle having such an information technology system.

Information technology systems, such as PCs or microcontrollers, for example in the form of embedded systems, comprise various electric and electronic components. Processors that execute code and memory elements that stockpile corresponding code and store information accruing during the processing of the code by the processor are of particular significance. The availability of free memory in the information technology systems is usually limited. While mass storage devices such as hard drives or SSDs have a comparatively large amount of memory space and are comparatively cheap, their access time by the processor is comparatively slow. Typically, the faster the access to a memory element by the processor, the smaller the available memory space is and therefore the more expensive the memory element is.

To reduce the run time of programs, it is desirable to distribute as much of the data processing as possible to memory elements that the processor has a comparatively short access time to.

The part of an operating system that manages the storage hierarchy is referred to as storage management. The storage management, together with PCs for example, should enable efficient and comfortable access to the physical working memory. During the run time of an operating system, information relating to the operating system itself and programs executed on the operating system are written into the working memory so that the computer's processor can access it. It may be the case that there is not enough working memory to hold all of the information. This is also referred to as “spillover”. The so-called dynamic storage management provides a remedy, in which the data that is not currently required is written from the working memory onto a respective mass storage medium, such as the hard drive or SSD. If this information is to be further processed, it is downloaded again into the working memory and other information is removed from this.

Dynamic storage management is possible using so-called bitmaps and linked lists.

A dynamic storage allocation method based on using linked lists is known from U.S. Pat. No. 5,784,698 A, for example. Here, the memory of a computer system is divided into a series of so-called buffer pools, which each comprise a plurality of buffers. The buffers in a respective buffer pool have the same size and differ in this respect across the various buffer pools. Now, if information is to be written into the memory, gradually the individual buffers are refilled, wherein as long as the respective largest free buffers are refilled with information until there is a surplus of information. It is then checked which buffer is still large enough to take this surplus. This makes it possible to provide the smallest possible buffer to take the surplus, which prevents too much unused memory from remaining in a written buffer. This ensures an efficient memory usage. However, it is a dynamic method and is accordingly complex.

Furthermore, DE 10 2019 217 844 A1 discloses a method for configuring a storage unit of a computing unit. This is a method for dynamic storage management that enables the reconfiguration of the storage unit during the regular operation of the computing unit. To this end, the classification of the storage unit into individual memory areas changes dynamically during the run time.

Microcontrollers place particular requirements on the storage management, as the computing resources present on a microcontroller are particularly scarce. Dynamic storage management on a microcontroller is therefore generally too complex, which is why static memory allocation is carried out. For this, the memory of the microcontroller is divided into individual segments, having a fixed assignment of which information that arises during operation is to be written to a particular storage segment during the execution of programs or program sections, also referred to as functions. The corresponding information is distributed gradually to the individual storage segments, whereby the available memory space of the memory is used up quickly. If the memory space is no longer sufficient, the information is to be relocated to another memory. This increases the run time of a corresponding program due to the latencies associated with the memory access.

Exemplary embodiments of the present invention are directed to an improved method for static allocation and assignment of information to memory areas of a processor-external memory of an information technology system, which allows an efficient operation of the information technology system.

A method for static allocation and assignment of information to memory areas of a processor-external memory of an information technology system of the type mentioned above, wherein the information technology system processes a plurality of concatenated functions during an execution iteration by a processor for solving a problem, wherein a respective function after being processing provides an item of output data as information, which can be read in by a function downstream in the information flow direction, and wherein a respective item of output data, for the purpose of being read in, is written into a separate memory area of the memory, to which the respective functions have access, is developed according to the invention in that, in a one-time analysis process, the information technology system:
checks which output data of the functions are processed simultaneously by the processor during an execution iteration;
assigns the output data to fixed memory areas, wherein each item of output data is assigned to precisely one fixed memory area, and wherein at least one first and one second item of output data, which are processed during the execution iteration by the processor at different time points, are assigned to the same fixed memory area; and
during an execution iteration, the information technology system in the standard operation:
writes the first item of output data into the fixed memory areas assigned to it and leaves same in the fixed memory area at least until the function requiring the first item of output data has been processed by the processor; and
writes the second item of output data into the same fixed memory area to replace the first item of output data, before the function which requires the second item of output data is processed by the processor.

The method according to the invention enables different output data to be assigned to the same memory areas, despite static storage allocation. As a result, the memory requirement of the memory is reduced, whereby either smaller memories can be installed in the information technology system, or the freed-up memory space can be used for other things.

This is made possible by the one-time analysis process that takes place separately from the standard operation of the information technology system. The method is suitable particularly for those information technology systems that operate in a restricted operating diagram, i.e., in a narrow region of fixed specified boundary conditions. These include microcontrollers, for example in the form of embedded systems, as a limited number of “standard program sequences” are processed here. This leads to the number of functions to be processed in a problem remaining manageable. Accordingly, the effort involved in checking which output data of the functions is processed simultaneously by the processor during an execution iteration and in carrying out the corresponding assignment of the output data to fixed memory areas can be kept within limits.

The one-time analysis process can then, for example, take place with the development of the information technology/embedded system. During the development of the embedded system, its requirements specification and thus the problems to be processed and the corresponding functions to be processed for this purpose are defined. In this way, it is firmly defined which output data is generated when, which allows the fixed memory allocation of the respective output data in accordance with the method according to the invention.

Two cases must be distinguished. The first case provides that functions that require the first item of output data are only present in the problem before the function (or functions) that require the second item of output data, while the second case provides that at least one function that requires the first item of output data is also present in the problem after such a function that requires the second item of output data. These cases will be discussed in detail below.

An advantageous further development of the method provides that a third item of output data is provided before a fourth item of output data and the third item of output data and the fourth item of output data are assigned to different fixed memory areas, if a function requiring the third item of output data is processed by the processor after a function requiring the fourth item of output data. The third item of output data and the fourth item of output data are therefore required by different functions, which are processed at different time points by the processor; nevertheless the third item of output data and the fourth item of output data are not suitable for joint allocation to the same memory area. This serves to fulfil said second case.

According to a further advantageous embodiment of the method, the memory is formed by a main memory, the information technology system is equipped with at least one auxiliary memory and in order to replace the first item of output data with the second item of output data, the first item of output data is discarded from the main memory or the first item of output data is relocated to the at least one auxiliary memory.

In general, the output data provided or read in by any function can form respectively a first, second, third, fourth or another item of output data, depending on which other item of output data the item of output data in question is related to. Here the term “first”, “second”, “third”, and “fourth” is only used to better differentiate the order of the processing in the information flow direction.

According to the first case, the first item of output data can be deleted from the fixed memory area and can be replaced by the second item of output data, since later the first item of output data is not needed for any further function.

According to the second case, the third item of output data cannot be easily deleted from the memory, since the third item of output data is still required after processing the fourth item of output data by at least one function. In order to solve this problem, two strategies come into question.

The third and fourth items of output data are written into separate memory areas, meaning that the problem that the third item of output data has to be removed from the memory area so that the fourth item of output data can be written into this does not even exist anymore.

Alternatively, it is possible to relocate the third item of output data into the auxiliary memory, as long as a function requires the fourth item of output data. Relocated in this context means that the third item of output data is also deleted from the main memory, but it is copied into the auxiliary memory before being discarded. The third item of output data and the fourth item of output data, as explained above, can be understood as analogous to the first and second items of output data.

A further advantageous embodiment of the method provides that the auxiliary memory has a different access time to the main memory, in particular a tightly coupled memory (TCM) is used as an auxiliary memory. In other words, the auxiliary memory can be formed by a physically differently designed memory element than the main memory. In this case, the access time, i.e., the time required for reading or writing information, can either be longer or also shorter. It is particularly advantageous when a TCM that thus has a particularly short access time, is used. A TCM may be such a memory element that is arranged physically very near to the corresponding processor. This enables particularly short access times. For example, it may be an SRAM multi-transistor memory module. The administration effort, also referred to as “overhead”, for storage management of a TCM is therefore lower than the administration effort for the cache of the processor. Along with the output data, time-critical routines can be kept in the TCM, such as so-called interrupt handling routines, real-time tasks and so-called interrupt stacks.

According to a further advantageous embodiment of the method, the information technology system solves at least two different problems, at least sometimes simultaneously. With the aid of information technology systems, the simultaneous processing of multiple problems is possible. The respectively present computing resources, therefore, must be distributed to the individual problems. The method according to the invention comes into its own here, in particular, since an efficient division of information is thus also possible on information technology systems with limited computing resources, in particular memory elements. In the analysis process, the information technology system then checks for all problems, which output data of the respective functions of all of the problems are simultaneously processed by the processor. Therefore, an efficient assignment of the respective output data of the functions of all problems to the fixed memory areas of the memory can also be carried out. The at least two different problems can be processed completely simultaneously by the processor, i.e. start and end simultaneously, or also have start or end points differing from each other.

A further advantageous embodiment of the method provides that the output data of the functions of a first problem are written onto the main memory and the output data of the functions of a second problem are written into one of the auxiliary memories. In general, all output data from other problems that differ from the first problem can be written into one and the same auxiliary memory or, if the information technology system has several auxiliary memories, the output data from separate problems can also be written into separate auxiliary memories. The dividing of the output data depending on the problems to be stored allows for even more efficient storage management. In particular, this is advantageous when no information, meaning output data, is to be exchanged between the problems. As a result, the computing resources are used particularly efficiently so that waiting time for writing or reading the output data for a respective problem to a memory element due to latencies does not block writing or reading access for the other problem. As a result, the execution time or resolution time of the individual problems is shortened. If two problems have been instructed to exchange information, the output data of these problems are written into a common memory.

According to a further advantageous embodiment of the method, the information technology system determines the memory requirement of each item of output data and only those items of output data that have a substantially identical memory requirement are assigned to the same fixed memory area. Substantially identical in this context means exactly the same, i.e., for example, two different items of output data are each 156 KB in size and that two different items of output data can also be different sizes, however only with a comparatively small difference. The first item of output data may be 128 KB, and the second item of output data may be 156 KB. The difference of the file size up to which two different items of output data are considered “substantially” identical in size, can be fixed or depend on the file size of the respective item of output data. For example, the permitted size difference can correspond to a proportional percent value, such as 10% or 20% of the file size of the item of output data. If, for example, an item of output data is 128 KB, the permitted deviation could be 13 or 26 KB.

The assignment of such substantially identically sized items of output data to fixed memory areas allows for a more efficient memory space usage of the memory. If output data of different sizes was to be assigned to the same fixed memory area, the available memory space on the memory would be wasted if only a comparatively small item of output data was stored after a particularly large item of output data. This can be prevented in this way.

A further advantageous embodiment of the method provides that the information technology system applies a genetic algorithm in the analysis process, in order to determine which items of output data are to be assigned to the same fixed memory area in each case. The question of which items of output data are to be assigned to which fixed memory area represents a Pareto-optimal optimization problem. In general, other optimization algorithms, such as a so-called greedy or dynamic optimization, can also be used which, however, do not have a polynomial run time anymore. A genetic algorithm, however, leads reliably in any situation to a converged solution. As a result, the reliability of detecting an optimum assignment is increased.

According to a further advantageous embodiment of the method, the first optimization target is to minimize the entire run time of the problems to be solved and the second optimization target is to minimize the proportion of the memory used by the fixed memory areas. For a user of the information technology system, it is of particular interest when the problems to be done are solved, i.e., processed, particularly quickly. This represents the main objective of the optimization. Furthermore, it is important to reduce the amount of memory space used so that it can be utilized for other purposes. Accordingly, this represents a constraint.

The run time of the problems and the proportion of the occupied memory are dependent on each other. With a previous static memory allocation, each item of output data is assigned to an individual fixed memory area. Accordingly, the memory is comparatively heavily utilized, and output data may have to be relocated. The more output data is moved to a stack present on an auxiliary memory, the longer the run time of the respective problem, as the respective output data has to be “swapped” between the main memory and the auxiliary memory. These access times lead to an increase of the latency and thus to a longer execution period of the problem. It is therefore desirable to assign as much output data as possible to one and the same memory area.

The method according to the invention precisely enables this, and thus results in more memory space being available on the memory, which, depending on the complexity of the problem to be processed, means that no more output data has to be relocated to the auxiliary memory.

As already explained above, cases can also occur however in which an item of output data is required again at a later point in time, which means that the corresponding item of output data cannot simply be deleted from the main memory. The output data must be assigned to the fixed memory areas in such a way that the required number of swapping operations is minimized, even if output data is assigned to one and the same fixed memory area several times. Taking into consideration the first and second optimization targets, a genetic algorithm in particular is particularly reliable at finding a comparatively optimal solution here.

According to the invention, an information technology system set up to carry out a method described above is designed as a microcontroller. The particular suitability of the method according to the invention for use in an environment designed as a microcontroller has already been explained above.

According to the invention, a vehicle comprises an above-described information technology system. Particularly advantageously, the information technology system is designed as a microcontroller. The method according to the invention can thus be integrated into the individual control devices or computing units of a vehicle and thus improves the efficiency of the respective hardware components. A particularly efficient memory usage is possible and in addition the run time of the problems processed by the individual control devices can be reduced.

The vehicle can be any vehicle such as a car, lorry, van, bus or similar. In addition to road vehicles, rail vehicles, watercraft or aircraft for example are also suitable for integration of said information technology systems.

Further advantageous embodiments of the method according to the invention for the static allocation of information to memory areas of a processor-external memory also result from the exemplary embodiments which are described in more detail below with reference to the figures.

### BRIEF DESCRIPTION OF THE DRAWING FIGURES

### Here:

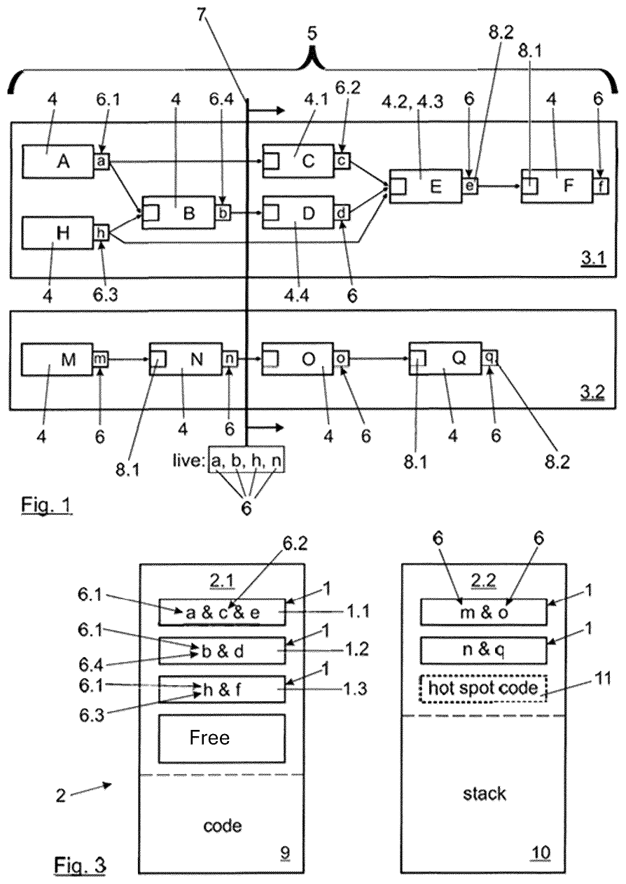

FIG. 1 shows a schematic representation of a component data flow graph of the functions used to solve a problem by an information technology system;

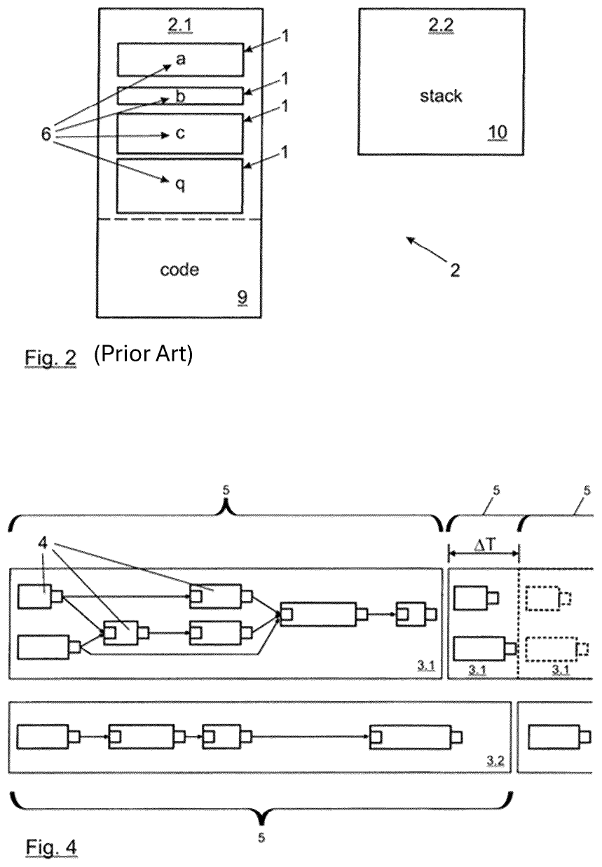

FIG. 2 shows a schematic representation of a classic memory allocation;

FIG. 3 shows a schematic representation of a memory allocation according to the invention; and

FIG. 4 shows a schematic representation of a component data flow graph of two problems differing in their run time.

### DETAILED DESCRIPTION

Information technology systems such as PCs or embedded systems are used daily to solve various problems. For this purpose, information is processed by a processor of the information technology system. FIG. 1 shows a component data flow graph of the information processed by the processor. For the sake of clarity, not all relevant points in the figures are labelled with reference signs.

A first and second problem 3.1 and 3.2 can be seen. The respective problems 3.1 and 3.2 can be formed from individual programs or subprograms. A problem 3.1, 3.2 is executed during an execution iteration 5. The current time point in the execution iteration 5 is referred to here as an execution position 7. To solve a respective problem 3.1, 3.2, individual functions 4 dependent or based on each other are processed by the processor. Such a function 4 is similarly formed from individual program code modules. A function 4 can have an input interface 8.1 for receiving output data 6 and an output interface 8.2 for outputting output data 6.

At any given time during the execution iteration 5, different items of output data 6 are active, also referred to as “live”. This means that this output data 6 has to be processed by the processor and is correspondingly available to the processor. In the exemplary embodiment shown, the output data 6: “a”, “b”, “h” and “n” are live at the execution position 7.

In order to be able to solve the problems 3.1, 3.2, the processor has to be able to access the respective output data 6. For this purpose, the output data 6, after it is produced, is written into a memory 2. The memory 2 is represented in more detail in FIGS. 2 and 3. In this case, FIG. 2 shows memory allocation according to a known method.

In the embodiment variations shown in the figures, the information technology system has a main memory 2.1 and an auxiliary memory 2.2. The auxiliary memory 2.2 is preferably a so-called tightly coupled memory (TCM). Typically, after it is produced by the functions 4, the output data 6 is written successively into the individual memory areas 1 of the memory 2. A part of the memory is reserved for code 9. For example, this may be code 9 used for training the functions 4.

The respective output data 6 can differ in its memory requirement, which is indicated in FIG. 2 by differently sized boxes.

Furthermore, the auxiliary memory 2.2 is used to store a so-called stack 10, which is used to store information, including said output data 6. As can be taken from FIG. 2, the main memory 2.1 is already completely filled according to a method for static memory allocation known from the prior art. The output data 6 generated in the further course of the execution iteration 5 cannot simply be written into the main memory 2.1. Output data 6 that is no longer required must then be relocated from the main memory 2.1 to the auxiliary memory 2.2. However, this is time-consuming due to the read access to the main memory 2.1 and write access to the auxiliary memory 2.2 and thus increases the execution time or run time of a respective problem 3.1, 3.2 during the embodiment iteration 5.

To reduce the memory requirement and to improve the run time, a method according to the invention is used for static memory allocation. This provides that in a one-time analysis process, the information technology system checks which output data 6 of the functions 4 are processed simultaneously by the processor during an execution iteration 5. The output data 6 is then assigned to fixed memory areas 1 in such a way that each item of output data 6 is assigned to precisely one fixed memory area 1, and wherein at least one first item of output data 6.1 and one second item of output data 6.2, which are processed during the execution iteration 5 by the processor at different time points, are assigned to the same fixed memory area 1. In standard operation during an execution iteration 5, the information technology system then writes the first item of output data 6.1 into the fixed memory area 1.1 assigned to it and leaves it there until the function 4.1 requiring the first item of output data 6.1 has been processed by the processor. The information technology system then writes the second item of output data 6.2 into the same fixed memory area 1.1 to replace the first item of output data 6.1, before the function 4.2 which requires the second item of output data 6.2 is processed by the processor. Generally, each of the items of output data 6 can form the first, second, or also a third or fourth item of output data 6.1, 6.2, 6.3 and 6.4. For example, the corresponding reference signs are chosen for the output data 6 “a” and “c”. The corresponding distribution to the memory 2 is shown in FIG. 3.

As can be taken from FIG. 1, the item of output data 6 “a” is no longer needed by the function 4 marked with the letter C after processing and is accordingly not live anymore. Accordingly, the item of output data 6 “a” can be replaced by the item of output data 6 “c”.

In a particularly simple embodiment of the method according to the invention, output data 6, which is not live any more during an execution iteration 5, is completely deleted from the main memory 2.1. Thus, relocation to the auxiliary memory 2.2 is not required. However, the memory space requirement on the main memory 2.1 increases, as the number of items of output data 6 that can be provided in one and the same fixed memory area 1 may be reduced.

The case which was referred to as the “second case” above can occur, namely that a third item of output data 6.3 (here, for example, the item of output data 6 “h”) is provided before a fourth item of output data 6.4 (here the item of output data 6 “b”), and the third item of output data 6.3 and the fourth item of output data 6.4 are assigned to different fixed memory areas 1.2 and 1.3 if a function 4.3 requiring the third item of output data 6.3 is processed by the processor after a function 4.4 requiring the fourth item of output data 6.4.

In general, however, it would be possible to assign the output data 6 ‘h’ and ‘b’ to the same fixed memory area 1, as these two items of output data 6 are not processed simultaneously by the processor. However, the item of output data 6 ‘h’ is needed again later, so it must be reloaded into the main memory 2.1 so that the processor or function 4.3 can access it. Alternatively, it would be possible to temporarily relocate the item of output data 6 “h” into the auxiliary memory 2.2. This saves even more storage space in main memory 2.1 but increases the run time of the respective problem 3.1 due to the data access. For example, the item of output data 6 ‘h’ must first be read from the main memory 2.1 and then written into the auxiliary memory 2.2 and then read from the auxiliary memory 2.2 and written into the main memory 2.1 again.

However, if the auxiliary memory 2.2 is sufficiently fast so that its access time is of the same order of magnitude as the clock frequency of the processor, for example in a TCM design, it may also be possible for the individual items of output data 6 to be read directly from the auxiliary memory 2.2 into the processor and not first written into the main memory 2.1. As a result, the run time of the execution iteration 5 can be further reduced.

In addition, so-called hotspot code 11 can also be provided in the auxiliary memory 2.2 when the auxiliary memory 2.2 is designed as a TCM. The so-called hotspot code 11 consists of code elements that are processed particularly frequently by the processor, for example the body or core of loops. As a result, the run time can be further reduced.

As FIG. 4 shows, each function 4 can have an individual processing time, indicated by boxes of different lengths. This results on the one hand from the access time required to read or write the corresponding output data 6 and the actual processor time to process the respective function 4. This can correspondingly lead to the individual problems 3.1 and 3.2 having a different execution period. As can be gathered from FIG. 4, the individual execution iterations 5 can be connected to each other seamlessly (solid line) for the respective problems 3.1 and 3.2. This fact is taken into consideration by the information technology system in the analysis process in order to determine which output data 6 of the individual functions 4 is processed simultaneously by the processor.

The information technology system, however, can also provide a pause in order to coordinate the execution iterations 5 of the first problem 3.1 with each other, so that the first problem 3.1 is only carried out again when the second problem 3.2 also starts again. This is symbolized in FIG. 4 by a dashed line and the time delay ΔT. This has the advantage that there is no delay in the processing time of the respective functions 4, so that the possible number of combinations of functions 4 or output data 6 to be processed simultaneously is reduced. However, this has the disadvantage that the frequency with which the first problem 3.1 is processed reduces. Depending on the application, it is important to consider which variant should be carried out by the information technology system.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-11. (canceled)

12. A method for static allocation and assignment of information to memory areas of a processor-external memory of an information technology system, wherein the information technology system processes a plurality of concatenated functions during an execution iteration by a processor to solve a problem, wherein after being processed, a respective function an item of output data as information, wherein the output data can be read in by a function downstream in an information flow direction, and wherein a respective item of the output data, for purpose of being read in, is written into a separate memory area of the memory, to which the respective functions have access,
wherein in a one-time analysis process, the information technology system
checks which of the output data of the functions are processed simultaneously by the processor during the execution iteration; and
assigns the output data to fixed memory areas, wherein each item of output data is assigned to precisely one of the fixed memory areas, and wherein at least one first and one second item of the output data, which are processed during the execution iteration by the processor at different time points, are assigned to a same fixed memory area; and
wherein during the execution iteration, the information technology system in a standard operation
writes the at least one first item of output data into the fixed memory areas assigned to the at least one first item of output data and leaves the at least one first item of output data in the fixed memory area at least until a function requiring the at least one first item of output data has been processed by the processor; and
writes the at least one second item of output data into the same fixed memory area to replace the at least one first item of output data, before the function requiring the second item of output data is processed by the processor.

13. The method of claim 12, wherein a third item of output data is provided before a fourth item of output data, and the third item of output data and the fourth item of output data are assigned to different fixed memory areas when a function requiring the third item of output data is processed by the processor after a function requiring the fourth item of output data.

14. The method of claim 12, wherein the memory comprises a main memory, the information technology system is equipped with at least one auxiliary memory and, to replace the at least one first item of output data with the at least one second item of output data, the at least one first item of output data is discarded from the main memory or the at least one first item of output data is relocated to the at least one auxiliary memory.

15. The method of claim 14, wherein the at least one auxiliary memory has a different access time to the main memory.

16. The method of claim 14, wherein the information technology system solves at least two different problems, at least sometimes simultaneously.

17. The method of claim 16, wherein output data of functions of a first problem are written into the main memory and output data of functions of a second problem are written into one of the at least one auxiliary memories.

18. The method of claim 12, wherein the information technology system determines memory requirement of each item of output data and only those items of output data having a substantially identical memory requirement are assigned to the same fixed memory area.

19. The method of claim 12, wherein the information technology system applies a genetic algorithm in the one-time analysis process to determine which items of output data are to be assigned to the same fixed memory area in each case.

20. The method of claim 19, wherein a the first optimization target is to minimize an entire run time of the problems to be solved and a second optimization target is to minimize a proportion of the processor-external memory used by the fixed memory areas.

21. An information technology system comprising a microcontroller and configured to perform the method of claim 12.

22. A vehicle, comprising the information technology system of claim 21.
